(19) United States
(12) Patent Application Publication
(10) Pub. No.: US 2006/0088309 A1
(43) Pub. Date: Apr. 27, 2006

(54) Device crane, especially camera crane

(75) Inventor: Dieter Hein, Windach (DE)

Correspondence Address: Rocco S Barrese;Dilworth & Barrese, 333 Earle Ovington Boulevard, Uniondale, NY, 11553, US

(73) Assignee: Rocco S. Barrese L.L.P., Uniondale, New York (US)

(21) Appl. No.: 10/515,368

(22) PCT Filed: Apr. 24, 2003
(86) PCT No.: PCT/EP03/04274

§ 371 Date: Jan. 3, 2006

(30) Foreign Application Priority Data
Mar. 22, 2002 (DE) 102-22-663.6

(51) Int. Cl. G03B 17/00

(52) U.S. Cl. 396/428

(57) ABSTRACT

The invention relates to a camera crane which comprises a crane jib (2) at the end of which a camera receiving platform (30) is pivotably mounted with dampening elements (34) interposed between. In this manner, the oscillations that are caused by a traction and control rope (9) expanding under the load of the camera can be dampened, thereby allowing a perfect operation of the camera.

### TECHNICAL FIELD

The invention relates to the field of lifting tackle and particularly to the field of crane technology in connection with the controlled guidance of equipments in three-dimensional spaces. The invention relates in particular to the guidance of a camera in a three-dimensional space by swiveling a crane jib with a camera attached to one of its ends.

### PRIOR ART

An equipment crane of this kind is known from DE 298 16 565 U1, DE 299 07 704 U1 and DE 299 16 225 U1. With the camera crane described there, the camera may be guided in a three-dimensional space by the swiveling motion of a crane jib, whereby parallelogram guidance enables the camera-receiving plate to be held in a specific alignment including also horizontal alignment during guidance through the three-dimensional space. However, it is also possible to change the rope guidance used in the parallelogram system so that there is no longer any parallelogram setting. The camera-receiving plate may be preadjusted in one direction or the other in relation to the setting angle.

### DESCRIPTION

The technical problem (object) of the invention is to define precisely in an equipment crane, particularly a camera crane of the type described at the start, the guidance of an equipment or a camera in the three-dimensional space.

This object is achieved by an equipment crane, particularly a camera crane, comprising a crane support and crane jib pivotably mounted thereon at a first articulation point. At one end of the crane jib an equipment receiving element is articulated to a second articulation point, to which a traction element is articulated at a third articulation point, which is at a distance from the second articulation point, the said articulation point being guided from there to the crane support, and where it is articulated to a fourth articulation point, which is at a distance from the first articulation point. In the swiveling range of the equipment receiving element and in the area of the second articulation point, there is a motion damping equipment by means of which the swiveling motion of the equipment receiving element may be damped.

The solution prevents, particularly in the case of a long crane jib and hence a long traction element, any length changes to the traction element caused by loading by a heavy equipment causing it to undergo unwanted oscillations. Even if a pre-stretched traction rope is used, it is not really possible to avoid length changes under relatively high loads in a crane of this type. In addition, the use of a non-extending traction rope results in a not insignificant cost. This can be avoided according to the invention because the extensions of the traction element or the traction rope are isolated by the damping equipment and so the equipment may be guided through the three-dimensional space exclusively with the desired movement.

Preferably, there are several damping elements that may be switched on or off selectively depending on the weight of the equipment. This enables the degree of the damping to be adapted to the camera weight in question and to the oscillation intensity, which is dependent upon the expansion of the traction element per se and the expansion in dependence on the length of the traction element. The motion damping equipment may be damped.

In order to achieve the damping effect in a simple way, the use of damping elements that are known per se is envisaged comprising an inner disk and an outer disk, with said inner disk being able to turn inside the outer disk with an interposed viscous fluid. The inner disk is firmly seated on an axis that turns with the equipment receiving element. The outer disk may be locked on the jib side. When the outer disk is locked, the damping disk functions as a damping element. If this locking is not applied, the inner disk and outer disk turn together without any damping action.

### BRIEF DESCRIPTION OF THE DRAWINGS

The drawings are a purely schematic representation of an example of an embodiment.

FIG. 1 is a perspective view of a camera crane according to the invention FIG. 2 is a perspective view of the side of the crane support to which the traction rope is attached and

FIG. 3 is a perspective view of the other side of the crane support to which the end of the traction rope is attached.

FIG. 4 is a perspective representation of the end of the crane jib with the camera-receiving plate FIG. 5 is a schematic side view of the end of the crane jib shown in FIG. 4, and

FIG. 6 is a section view along the line VI-VI in FIG. 5.

### DESCRIPTION OF AN EXAMPLE OF AN EMBODIMENT

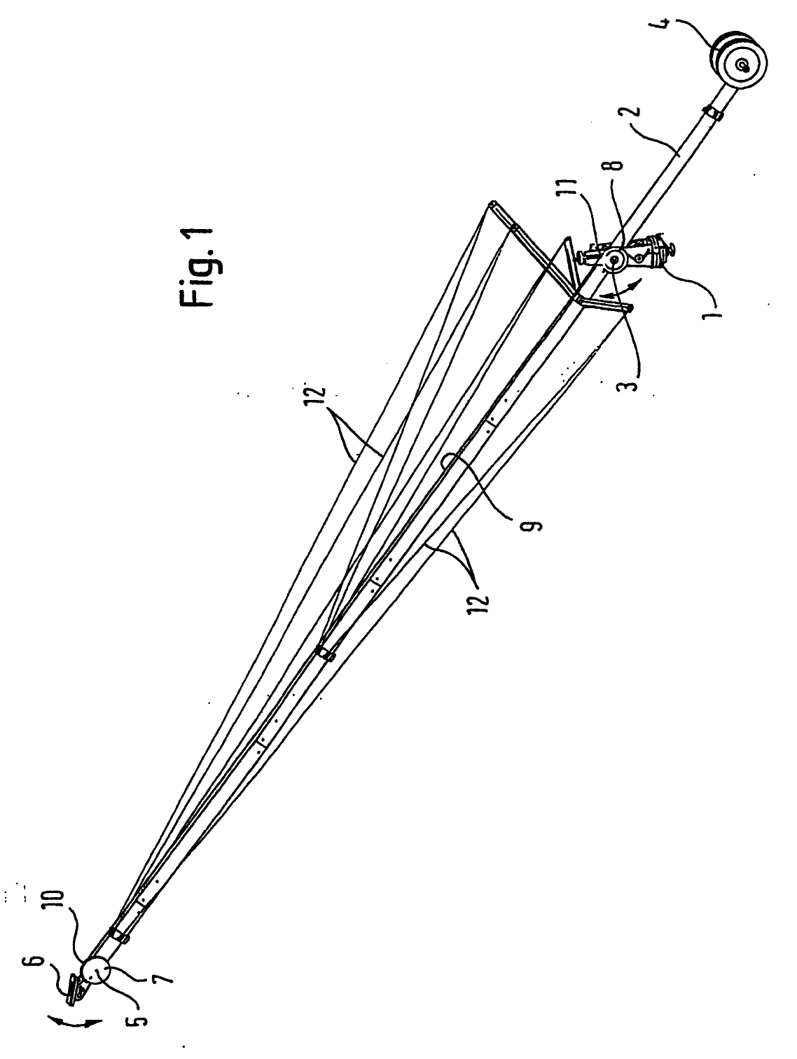

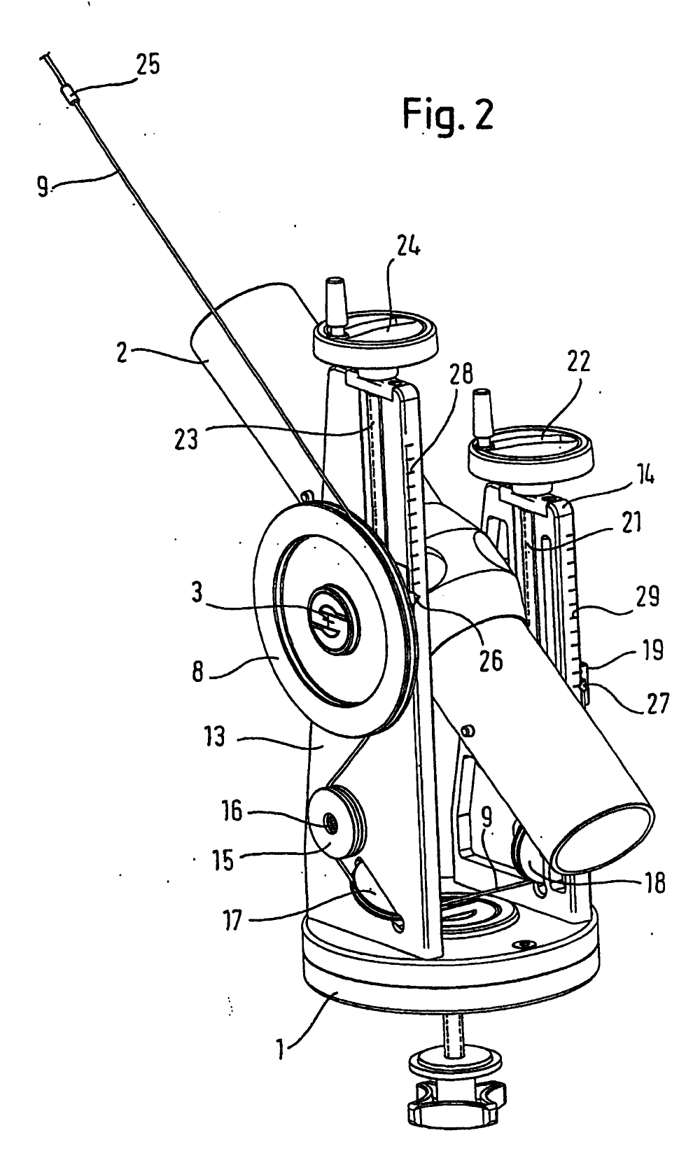

A camera crane shown in FIG. 1 comprises a crane support 1, only part of which is shown in FIG. 1. The lower part of the crane support 1 is not shown here, but may take the form of a tripod. In addition, the camera crane comprises a crane jib 2 which is pivotably mounted on a first articulation point 3 on the crane support 1. There is a counterweight 4 on the right-hand end of crane jib 2 in the drawing. A camera-receiving plate 6 designed as camera-holding element is pivotably mounted at the opposite end of the crane jib 2 at a second articulation point 5. In the embodiment shown here (to which the invention is not restricted), a rope pulley 7 is pivotably mounted together with the camera-receiving plate 6 with its center in the area of the second articulation point 5. Without implying any restriction to this example of an embodiment, a similar rope pulley 8 is located at the first articulation point 3 so that its center is arranged on this articulation point, which is simultaneously the swivel axis of the crane jib 2. Between these pulleys 7 and 8, a traction rope 9 runs in such way that a third articulation point 10 is formed on the tangential contact point of the traction rope 9 on the circumference of the rope pulleys 7 and 8 in the area of the camera-receiving plate 6 and a fourth articulation point 11 is formed in the area of the crane jib pivot mounting. If this traction rope 9, which is simultaneously a control rope, runs parallel to the crane jib 2, the crane jib together with the traction rope 9 and the articulation points 3,5, 10, 11 form a parallelogram system in such a way that when the crane jib 2 is swiveled, the camera-receiving plate 6 may be held in either an exactly horizontally aligned position or in a specific inclined position if the camera-receiving plate 6 is moved in the three-dimensional space by means of the crane jib 2 when it is swiveled in the crane support 1.

The crane jib 2 may then have a relatively lightweight design if it is reinforced by rope struts 12. In addition, the length of the crane jib 2 can be altered if, for example, the crane jib is telescopic or if the crane jib 12 comprises several sections that are inserted into each other so that it may be shortened or lengthened. Here, the rope struts 12 are slung on as appropriate and the course of the traction rope 9 is also suitably adapted, that is shortened or lengthened.

If a telescopic jib is involved in the crane jib length adjustment, this expression also covers the aforementioned plug-in connection.

The rope pulleys 7 and 8 do not have to, but can be, pivoted, whereby the rope pulley 8 is preferably pivoted about its axis. The rope pulley 7 may normally be pivoted with the camera-receiving plate 6.

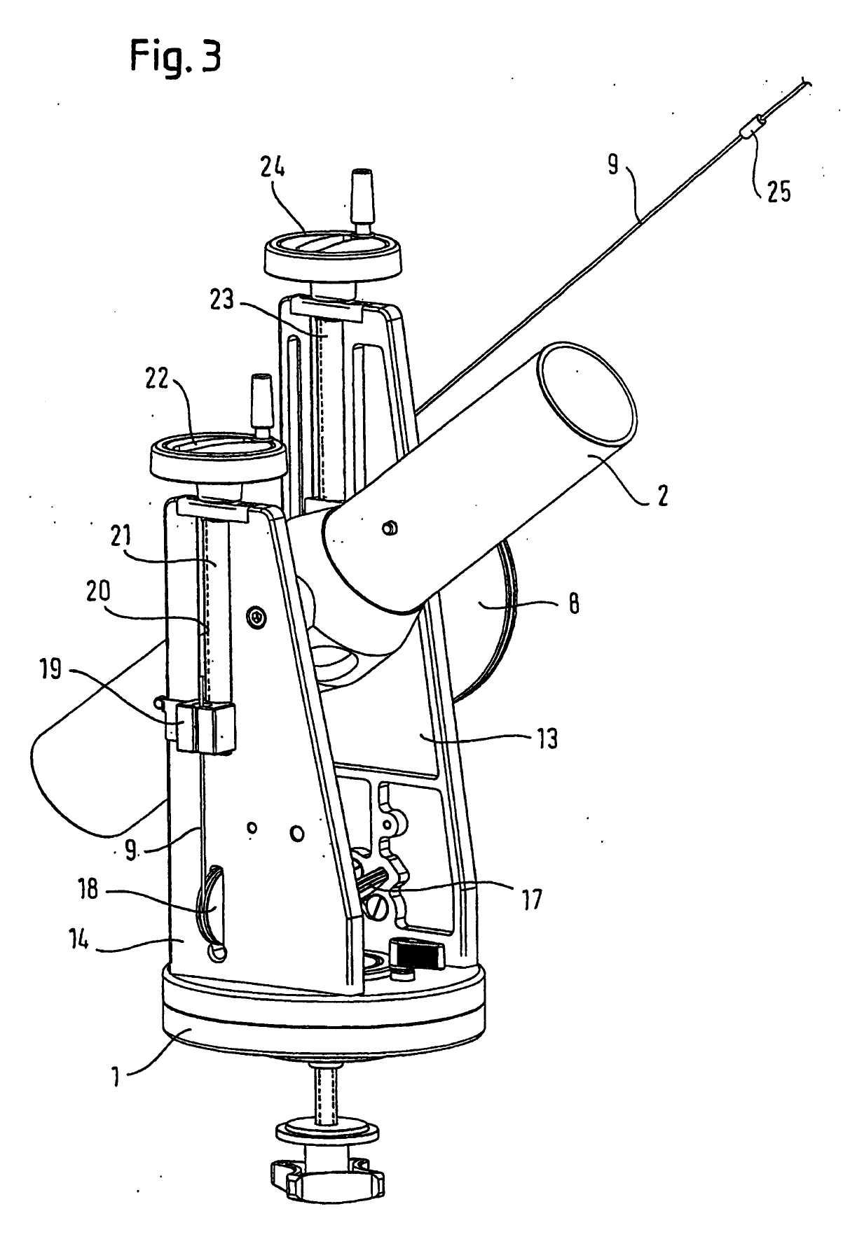

The crane support shown in isolation in FIG. 2 with no supporting structure only illustrates one part of the crane jib 2. However, FIG. 2 shows individual details more clearly than FIG. 1, particularly the rope pulley 8 with the first articulation point 3, which is located in the swivel axis of the crane jib 2 and which stays with the axis of the rope pulley 8 when the parallelogram system is adjusted. Also clearly identifiable is the traction rope 9, which emerges from the rope pulley 7, not shown, runs partially about the rope pulley 8 and continues, whereby the end of the rope is attached to the crane support 1. This may, in principle, be provided on the same side of the crane support. Here, the rope pulley 8 is located on one side of the crane support and the fixed end of the traction rope 9 is located at the other end of the crane support, whereby a major support 13 and a minor support 14 are provided. Although it is also possible to fix the rope end on the crane support 1 on the same side, that is, on the side of major part support 13, this drawing shows a split solution in which the traction rope 9 is guided partially around the rope pulley 8 and from there guided partially around a deflection pulley 15. The axis of rotation 16 of this deflection pulley 15 runs parallel to the axis of the rope pulley 8. From the deflection pulley 15, the traction rope 9 runs partially around a deflection pulley 17 whose axis rotates perpendicular to the axis 16 of the deflection pulley 15. From there, the traction rope 9 runs from the major support 13 to the minor support 14 and in this is again guided around another deflection pulley 18, which may also be seen in FIG. 3. From there, the traction rope 9 runs to a suspension element 19 forming a latching point. This suspension element 19 is mounted displaceably in a recess 20 in the minor support 14, and, to be precise, in the direction corresponding to the course of the traction rope 9 at this point. Here, this suspension element 19 takes the form of a spindle nut and sits on a spindle bolt 21. If this spindle bolt 21 is turned by means of a rotary lever 22, the position of the suspension element 19 relative to its position in the direction of the spindle bolt 21 may be changed. The consequence is that traction is applied to the traction rope 9 in the relevant direction. This in turn has the result that the angle of the camera-receiving plate 6 changes. This adjustment possibility may also be used to set the desired angle of the camera-receiving plate 6. If parallelogram guidance is set by means of the traction rope 9 and the crane jib 2, this position may then be maintained in the event of the crane jib being swiveled. However, it is possible to dispense with this parallelogram guidance. To do this, a similar spindle-nut system with a spindle bolt 23 and a lever 24 may be used to change the position of the rope pulley 8 in the major support 13 and indeed in approximately the same direction as the adjustment of the suspension element 19, which on the one hand permits the exact adjustment of the parallelogram system, but on the other hand an adjustment may be made in that the traction rope 9 leaves the parallelogram system to a greater or lesser extent. This adjustment results in a change to the angular position of the camera-receiving plate 6 and also the desired setting of the change to the angle of the camera-receiving plate during the swiveling of the crane jib.

The suspension of the end of the traction rope 9 in the suspension element 19 is achieved by a receiving or latching element 25 fixed to the traction rope, which is not identifiable in suspended condition but is implemented by a latching element 25 shown in the path of the traction rope 9, which takes effect when the crane jib 2 is shortened. Then, the traction rope 9 is pulled through the described deflection equipment and at the same time the latching element 25 suspended so that there is a surplus of traction rope 9 that may be suspended at a suitable point on the crane support 2 so that this surplus is not an impediment.

The rope pulley 8 is provided with a pointer 26 and das suspension element 19 is provided with a pointer 27. These pointers 26, 27 interact with a scale 28 or 29 in such a way that it is easily possible to introduce a corresponding visible adjustment.

Decoupling the adjustment on two sides enables a clearer layout and a more effective setting.

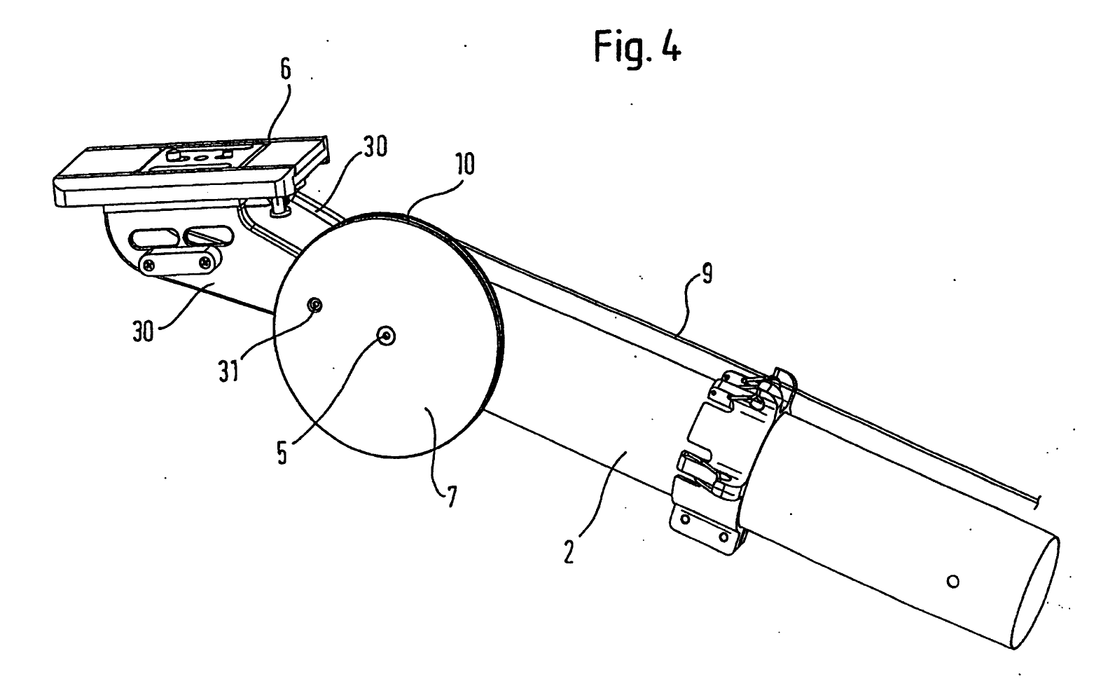

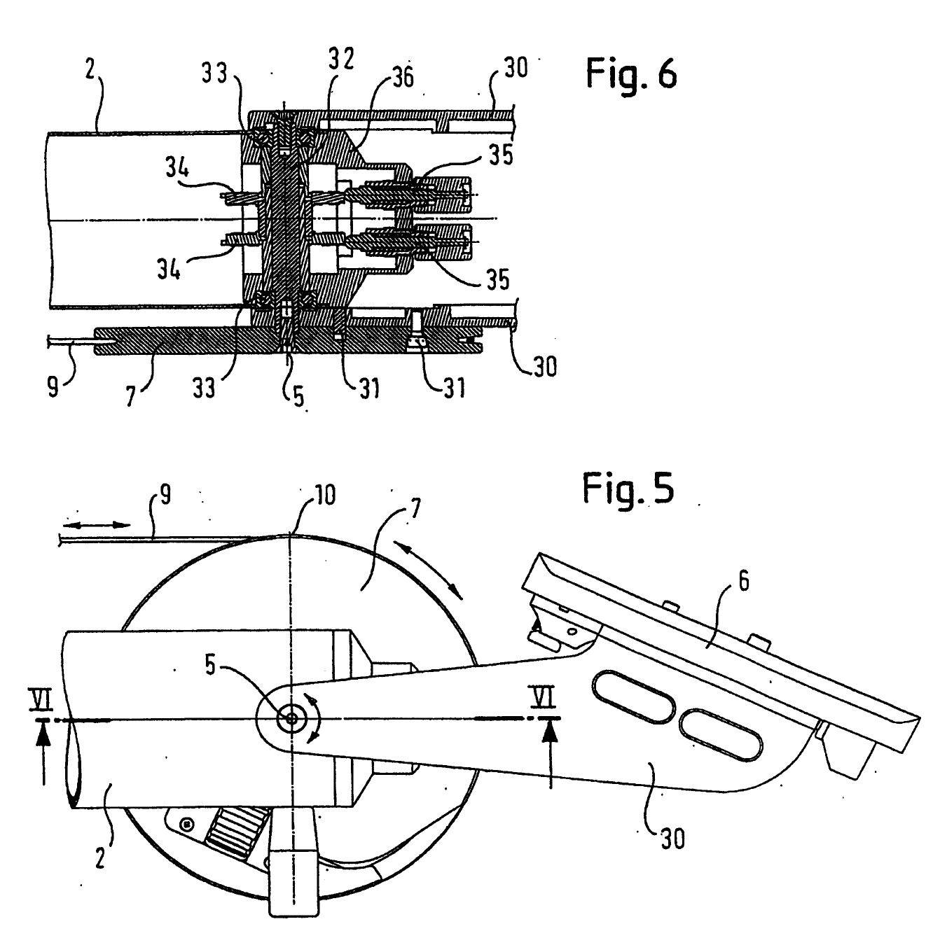

FIG. 4 is a better illustration than FIG. 5 of the camera-side end of the crane jib 2 which shows the rope pulley 7 for the traction rope 9 with the articulation point 5 for the camera-receiving plate 6 and the articulation point 10 for the traction rope 9. The camera-receiving plate 6 comprises two holding bars 30, of which one is firmly connected to the rope pulley 7, and therefore turns together with this, as may be seen more clearly in FIG. 6, by the connecting element 31. The holding bars 30 are firmly connected to an axis 32 mounted in rolling bearings 33 in a crane jib end piece 34. In this example of an embodiment, attached to this axis 32 are two damping elements 34, which are shown and described as damping disks which are known per se in DE 2657 692 C2. These damping disks comprise an inner disk, which, with an interposed viscous fluid, is able to turn inside an outer disk, whereby the inner disk is firmly connected to the axis 32 and turns with this when the camera-receiving plate 6 is swiveled. The circumference of the outer disk is provided with latching recesses, not shown here. Locking elements 35 may be screwed into these latching recesses, preferably spring-loaded. This puts the damping element into action, because the outer disk is secured on the jib side, while the inner disk is able to turn with the axis 32 and hence with the camera-receiving plate 6, although it is damped by the viscous fluid. Optionally, one or two and, if there are more damping elements even more, damping elements may be switched on together or in different graduations. When the damping element 34 is switched off, the outer disk turns freely with the inner disk without this causing any relative movement between the inner disk and outer disk and a damping action.

If the crane jib 2 is swiveled in the three-dimensional space and the weight of the camera on the camera-receiving plate 6 causes the traction rope 9 to expand changeably, oscillations are transmitted by the traction rope 9 onto the camera-receiving plate 6 and hence onto the camera; these oscillations are to be prevented. This is achieved by decoupling these oscillations by means of the damping described above.

1-3. (canceled)

4. Equipment crane, particularly camera crane, with a crane support (1) and a crane jib (2) articulated pivotably thereto at a first articulation point (3), at the end of which an equipment-receiving element (6) is articulated to a second articulation point (5), attached to which at a third articulation point (10), which is at a distance from the second articulation point (5), is a traction element (9) which is guided from there to the crane support (1) and there articulated to a fourth articulation point (11) characterized in that a motion damping equipment (34, 35) is arranged in the swivel range of the equipment-receiving element (6) and in the area of the second articulation point (5) which is able to damp the swivel movement of the equipment-receiving element (6) around the second articulation point (5).

5. Equipment crane according to claim 4, wherein provided as a damping equipment are several damping elements (34) that may be selectively switched on or off (35).

6. Equipment crane according to claim 4, wherein connected to an axis (32), via which the equipment-receiving element (6, 30) at the end of the crane jib (2) is mounted pivotably therein, are damping disks (34), each comprising an inner disk attached to the axis (32), which is arranged, with an interposed viscous fluid, pivotably in an outer disk, which may be locked on the jib side.
